(19) United States
(12) Patent Application Publication
(10) Pub. No.: US 2017/0338715 A1
(43) Pub. Date: Nov. 23, 2017

(54) Motor

(71) Applicant: Johnson Electric S.A., Murten (CH)

(72) Inventors: Yue LI, Hong Kong (CN); Mao Xiong JIANG, Shenzhen (CN); Xiu Feng ZHANG, Shenzhen (CN); Heng Gang WU, Shenzhen (CN); Hai Jun HUA, Shenzhen (CN); Jian ZHAO, Shenzhen (CN); Yong LI, Shen Zhen (CN); Yong WANG, Shen Zhen (CN); Ya Ming ZHANG, Shen Zhen (CN)

(21) Appl. No.: 15/597,819

(22) Filed: May 17, 2017

(30) Foreign Application Priority Data
May 18, 2016 (CN) 2016 1033 3756.7

(51) Int. Cl. H02K 7/08; H02K 1/27; H02K 1/14; H02K 3/18; H02K 5/20; H02K 9/02

(52) U.S. Cl. CPC H02K 7/08; H02K 5/20; H02K 9/02; H02K 1/146; H02K 3/18; H02K 1/2786; H02K 2213/03

(57) ABSTRACT

A motor includes a rotor having permanent magnets, and a stator having a stator core. The stator core includes a magnetic yoke and a plurality of stator teeth. Each stator tooth includes a tooth portion and a pole shoe. A slot with a width C is defined between neighboring pole shoes. A minimum distance between one of the pole shoes and the corresponding one of the permanent magnets is defined as D. A distance from a slot center point of one of the slot of the stator core to an air gap centreline along a radial direction of the stator core is defined as B. A distance from the air gap centerline to the corresponding one of the permanent magnets along the axial direction of the stator core through the slot center point is defined as A. The values of A, B, C and D satisfy the following formulas: A=B; A+B=(4˜5)*D; C=(0.9˜1.1)*(A+B).

### CROSS REFERENCE TO RELATED APPLICATIONS

This non-provisional patent application claims priority under 35 U.S.C. §119(a) from Patent Application No. 201610333756.7 filed in The People's Republic of China on May 18, 2016 .

### FIELD OF THE INVENTION

The present invention relates to the field of motors, and in particular to an improved motor.

### BACKGROUND OF THE INVENTION

Motors are devices that convert electrical energy to mechanical energy, which have been widely applied in a variety of industries. A motor typically includes a rotor and a stator, and the rotor is driven to rotate relative to the stator by interaction between magnetic fields of the rotor and the stator. NVH is an English abbreviation for Noise, Vibration and Harshness. How to improve NVH performance of the motor has become a major research subject.

### SUMMARY OF THE INVENTION

Thus, there is a desire for a motor with improved NVH performance.

A motor includes a rotor having permanent magnets, and a stator having a stator core. The stator core includes a magnetic yoke and a plurality of stator teeth. Each stator tooth includes a tooth portion and a pole shoe. A slot with a width C is defined between neighboring pole shoes. A minimum distance between one of the pole shoes and the corresponding one of the permanent magnets is defined as D. A distance from a slot center point of one of the slot of the stator core to an air gap centreline along a radial direction of the stator core is defined as B. A distance from the air gap centerline to the corresponding one of the permanent magnets along the axial direction of the stator core through the slot center point is defined as A. The values of A, B, C and D satisfy the following formulas: A=B; A+B=(4˜5)*D; C=(0.9˜1.1)*(A+B).

Preferably, the pole face of each permanent magnet includes an curved segment at the circumferential center thereof, and two chamfers respectively adjoining opposite sides of the curved segment.

Preferably, a curvature of the curved segment is equal to that of the external end surface of the pole shoe.

Preferably, the value of D is equal to a distance between a central point of an external end surface of one of the pole shoes and a central point of the pole face of one of the permanent magnets in response to the pole shoe being completely aligned with the permanent magnet.

Preferably, the motor is an outer-rotor motor, and the stator teeth are disposed at an outer circumferential surface of the magnetic yoke.

Preferably, the stator further includes stator windings corresponding to the stator teeth, and each of the stator windings is wound around the tooth portion of one stator tooth.

Preferably, the stator further comprises a bobbin, the bobbin is formed on an outer surface of the stator core by injection molding, the stator core is accommodated in the bobbin, and the stator windings are wound around the bobbin.

Preferably, the bobbin comprises an annular frame and a plurality of winding brackets connected to an outer circumferential surface of the annular frame, each of the winding brackets comprises a winding block and a curved baffle, a receiving groove is defined in each of the winding brackets towards the annular frame, the stator core is received in the receiving groove, an external end surface of the pole shoe is flush with an external end surface of the curved baffle, the tooth portions are received in the winding blocks, the magnetic yoke is received in the annular frame, and the stator windings are respectively wound around the winding blocks.

Preferably, a plurality of mounting holes is defined in the annular frame along an axial direction of the bobbin, and the stator is connected to an external component by a plurality of fasteners passing through the corresponding mounting holes to connect with the external component.

Preferably, a damping member is mounted in each of the mounting holes, and the stator is connected to the external component by the fasteners passing through the corresponding damping members to connect with the external component.

Preferably, the stator further comprises a plurality of terminals, and the terminals are connected to the annular frame.

Preferably, protruding blocks protrude from the annular frame, corresponding to the terminals, a connection groove is defined in a distal end of each of the protruding blocks, and the terminals are inserted into the connection grooves, respectively.

Preferably, the bobbin further comprises an hollow accommodating tube, the annular frame extends from an outer circumferential surface of the accommodating tube along an axial direction, positioning spaces are defined in two ends of the accommodating tube, each of the positioning spaces accommodates a bearing, the rotor further comprises a rotary shaft, and the rotary shaft extends through the accommodating tube, with the bearings disposed around the rotary shaft.

Preferably, a ring gasket is disposed between at least one of the bearings and the accommodating tube.

Preferably, the rotor comprises a housing, the housing comprises an end wall and a lateral wall, the end wall and the lateral wall cooperatively bounding an accommodating chamber, the stator is accommodated in the accommodating chamber, the permanent magnets are installed to the lateral wall, the rotary shaft further extends through the end wall and is fixed relative to the end wall.

Preferably, a washer is attached around the rotary shaft, and the washer is disposed between the end wall and one of the bearings.

Preferably, a protrusion protrudes from one side of the end wall away from the lateral wall, and the rotary shaft extends through the protrusion and is interference-fit with the protrusion.

Preferably, a plurality of heat dissipation holes is defined in the end wall.

### BRIEF DESCRIPTION OF THE DRAWINGS

FIG. 1 is a perspective view of a motor according to one embodiment of the present invention.

FIG. 2 is an exploded view of the motor shown in FIG. 1.

FIG. 3 is an exploded view of the motor shown in FIG. 1, viewed from another aspect.

FIG. 4 is a sectional view of the motor shown in FIG. 1, taken along line IV-IV thereof.

FIG. 5 is a sectional view of the motor shown in FIG. 1, taken along line V-V thereof

FIG. 6 is an enlarged view of a portion of a permanent magnet and a stator tooth shown in FIG. 5.

Below, embodiments of the present invention will be described in detail with reference to the accompanying drawings.

### DETAILED DESCRIPTION OF THE PREFERRED EMBODIMENTS

The technical solutions of the embodiments of the present invention will be clearly and completely described as follows with reference to the accompanying drawings. Apparently, the embodiments as described below are merely part of, rather than all, embodiments of the present invention. Based on the embodiments of the present invention, any other embodiment obtained by persons skilled in the art without paying any creative effort shall fall within the protection scope of the present invention.

It is noted that, when a component is described to be “fixed” to another component, it can be directly fixed to the another component or there may be an intermediate component. When a component is described to be “connected” to another component, it can be directly connected to the another component or there may be an intermediate component. When a component is described to be “disposed” on another component, it can be directly disposed on the another component or there may be an intermediate component.

Unless otherwise specified, all technical and scientific terms have the ordinary meaning as commonly understood by people skilled in the art. The terms used in this disclosure are illustrative rather than limiting. The term “and/or” used in this disclosure means that each and every combination of one or more associated items listed are included.

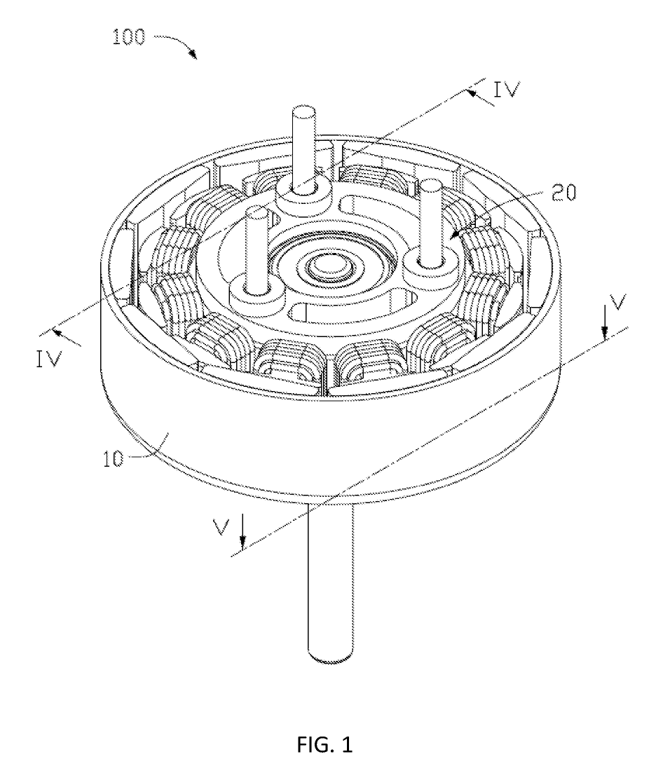

Referring to FIG. 1, a motor 100 according to one embodiment of the present invention includes a rotor 10 and a stator 20. In this embodiment, the motor 100 is an outer-rotor motor, the stator 20 is accommodated in the rotor 10, and the rotor 10 is capable of rotating relative to the stator 20. In this embodiment, the motor 100 may be used in a fan of an air conditioning system. It should be understood that the motor 100 may also be used in other electric appliances.

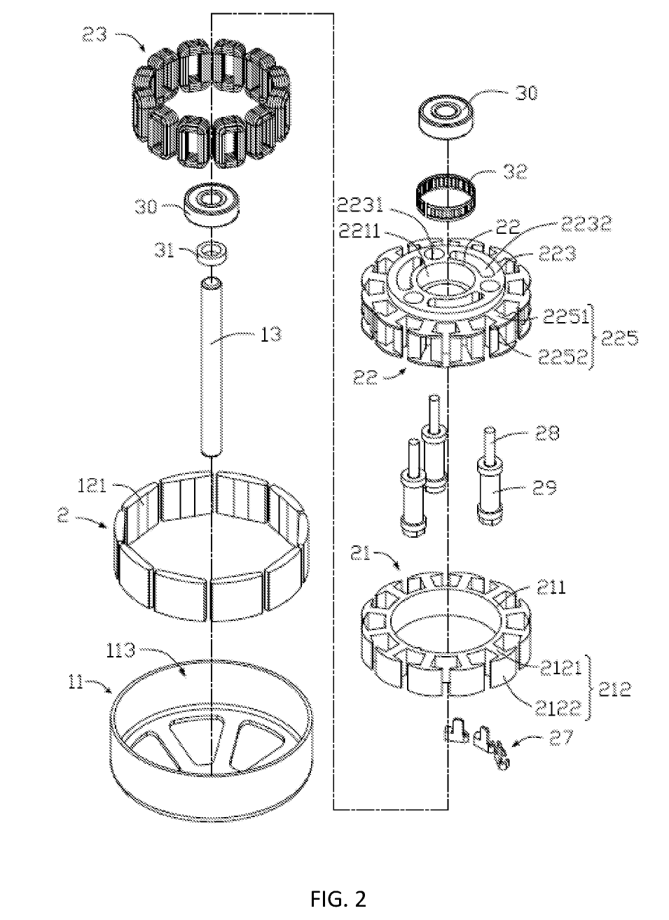

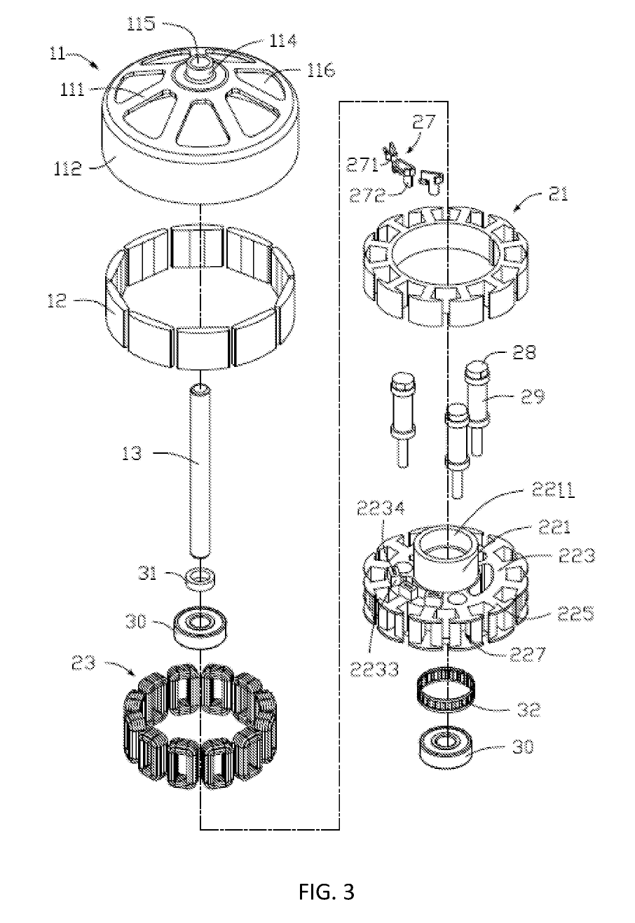

Referring to FIG. 2 and FIG. 3, the rotor 10 includes a housing 11, a plurality of permanent magnets 12 and a rotary shaft 13.

The housing 11 includes an end wall 111 and a lateral wall 112. The end wall 111 and the lateral wall 112 cooperatively bonding an accommodating chamber 113 for accommodating the stator 20. The end wall 111 is substantially of a conical shape, and gradually shrinks towards an end away from the lateral wall 112. A protrusion 114 protrudes from a center of the end of the end wall 111 away from the lateral wall 112. The protrusion 114 is substantially of a cylindrical shape. A through hole 115 is defined in a distal end of the protrusion 114, and extends through the end wall 111 in an axial direction of the housing 11. A plurality of heat dissipation holes 116 is defined in the end wall 111 around the protrusion 114, for facilitating heat dissipation when the motor 100 works.

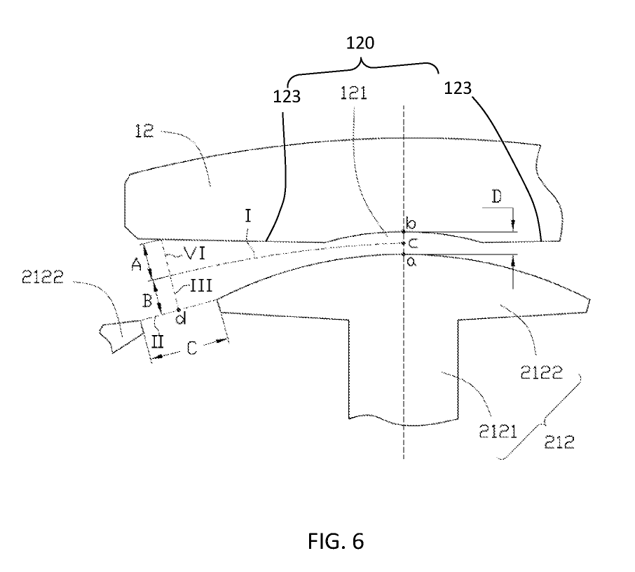

In this embodiment, the number of the permanent magnets 12 is ten, and the ten permanent magnets 12 are mounted on an inner surface of the lateral wall 112 at even intervals. In other embodiments, the number of the permanent magnets 12 may be adjusted according to needs. Referring also to FIG. 6, each permanent magnet 12 defines a pole face 120 facing the stator core 21. The pole face 120 of each permanent magnet 12 includes an curved segment 121 at the circumferential center thereof, and two chamfers 123 respectively adjoining opposite sides of the curved segment 121. In one embodiment, a curvature of the curved segment 121 is equal to that of the external end surface of the pole shoe 2122.

One end of the rotary shaft 13 extends into the through hole 115 and is interference-fit with the protrusion 14, such that the rotary shaft 13 is fixed relative to the housing 11. It should be understood that the rotary shaft 13 may alternatively be connected with the housing 11 in other manners such as through snap-fit connection.

The stator 20 includes a stator core 21, a bobbin 22 and a plurality of stator windings 23.

The stator core 21 includes a magnetic yoke 211 and a plurality of stator teeth 212. The magnetic yoke 211 is of a circular ring shape. The stator teeth 212 are disposed on an outer circumferential surface of the stator yoke 211 at even intervals. In this embodiment, the stator core 21 is exemplarily illustrated as including twelve stator teeth 212. The number of the stator teeth 212 is not limited and, in other embodiments, the number of the stator teeth 212 may be adjusted according to needs. Each of the stator teeth 212 includes a tooth portion 2121 and a pole shoe 2122. The tooth portion 2121 is substantially in the form of a rectangular block, with an end thereof being connected to the outer circumferential surface of the magnetic yoke 211. The pole shoe 2122 is substantially of an arc shape, and is connected to an end of the tooth portion 2121 away from the magnetic yoke 211. The pole shoe 2122 is symmetrically disposed about the tooth portion 2121. The stator core 21 is usually made of soft magnetic materials with high magnetic permeability, such as common carbon structural steel, silicon steel sheets and magnetically permeable alloys. Preferably, the stator core 21 is made of silicon steel sheets. The stator core 21 may be manufactured by stamping core laminations which are stacked along an axial direction of the stator core 21, or by a press-mounting process.

The bobbin 22 includes an accommodating tube 221, an annular frame 223 and a plurality of winding brackets 225. The accommodating tube 221 is of a hollow cylindrical shape, and cylindrical positioning spaces 2211 are respectively defined in two ends of the accommodating tube 221. The annular frame 223 extends from an outer circumferential surface of the accommodating tube 221 along an radial direction. A plurality of mounting holes 2231 and through slots 2232 are defined in the annular frame 223 along an axial direction of the bobbin 22. In this embodiment, each of the mounting holes 2231 is round, and each of the through slots 2232 is arc-shaped. The number of either of the mounting holes 2231 and the through slots 2232 is three, and the mounting holes 2231 and the through slots 2232 are distributed around the accommodating tube 221 at intervals. Three protruding blocks 2233 are further disposed on the annular frame 223. A connection groove 2234 is defined in a distal end of each protruding block 2233. The connection groove 2234 is substantially of a rectangular shape. The shape of the winding bracket 225 is substantially the same as that of the stator teeth 212. The number of the winding brackets 225 is equal to the number of the stator teeth 212. The winding bracket 225 includes a winding block 2251 and a curved baffle 2252. The winding block 2251 is substantially of a rectangular shape. An end of the winding block 2251 is connected with a circumferential surface of the annular frame 223, and the other end of the winding block 2251 is connected with the curved baffle 2252.

A receiving groove 227 is defined in each of the winding brackets 225. The receiving groove 227 has substantially the same shape as the stator core 21. When the stator core 21 is received in the receiving groove 227, an external end surface of the pole shoe 2122 is curved and flush with an external end surface of the curved baffle 2252.

In this embodiment, the stator core 21 is formed by stacking a plurality of core laminations along an axial direction of the stator 20. In fabrication and assembly, the laminations are connected by simple riveting to form the stator core 21, and plastic or rubber is injected over an outer surface of the stator core 21 to form the bobbin 22. The accommodating tube 221, the annular frame 223 and the winding brackets 225 of the bobbin 22 are integrally formed.

The number of the stator windings 23 is equal to the number of the winding brackets 225. The winding block 2251 of each winding bracket 225 is wound with one stator winding 23.

The stator 20 further includes a plurality of terminals 27. In this embodiment, the number of the terminals 27 is three. Two bent connection portion 271 are respectively formed at two adjacent side edges of each terminal 27, facilitating wiring (not shown) connection between the terminal 27 and one corresponding stator winding 23, thereby achieving connection between the stator windings 23. The terminal 27 further includes an inserting plate 272 extending from the side end where the connection portion 271 is provided. The inserting plate 272 is substantially of a rectangular shape. In this embodiment, the number of the terminals 27 is three, and the inserting plate 272 of each terminal 27 is inserted into the connection groove 2234 of one protruding block 2233, so as to fix the corresponding terminal 27 relative to the bobbin 22. In this embodiment, the inserting plate 272 of each terminal 27 is received in the connection groove 2234 during injection molding of the bobbin 22, so as to fix the terminal 27 relative to the bobbin 22.

It should be understood that, the terminal 27 may also be fixed to the bobbin 22 via snap-fit connection or interference fit between the inserting plate 272 and the connection groove 2234.

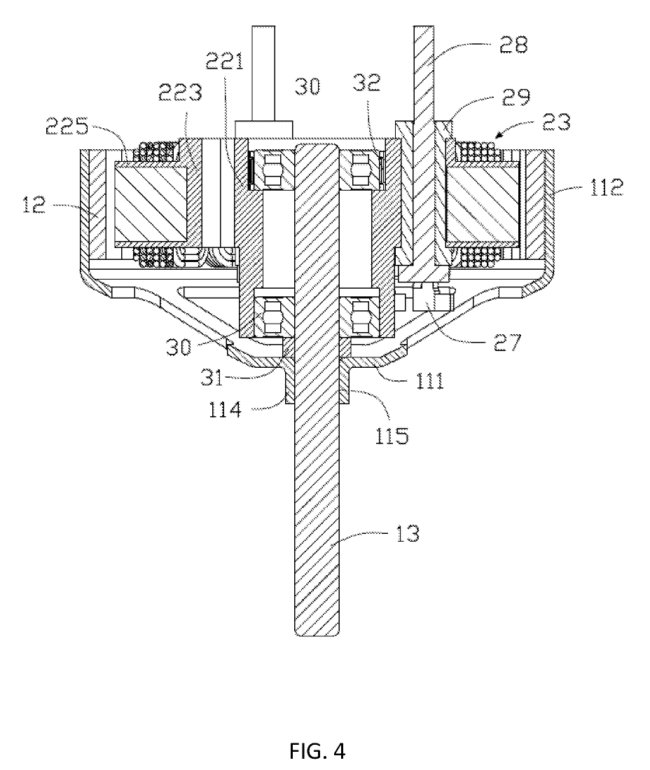

The stator 20 further includes a plurality of fasteners 28. The stator 20 is fixed to an external component by the fasteners 28 passing through the respective mounting holes 2231 to connected with the external component. Referring also to FIG. 4, the stator 20 further includes a plurality of damping member (29)s 29. Each of the damping member (29)s 29 is substantially of an “I” shape and is installed in a corresponding one of the mounting holes 2231, and two ends of each damping member (29) 29 protrude laterally, such that the damping member (29) 29 can be retained in the corresponding mounting hole 2231. The fasteners 28 extend through the damping member (29)s 29 and are fixed to the external component, so as to fix the stator 20 to the external component. In this embodiment, the damping member (29)s 29 are received in the mounting holes 2231 when the bobbin 22 is formed through injection, so as to fix the damping member (29)s 29 with respect to the bobbin 22.

Referring also to FIG. 2 to FIG. 4, the motor 100 further includes two bearings 30. Each bearing 30 is accommodated in one positioning space 2211. One end of the rotary shaft 13 extends into the accommodating tube 221, with the two bearings attached around the rotary shaft 13. In this embodiment, a washer 31 is further disposed between the bearing 30 adjacent the end wall 111 and the end wall 111. The washer 31 is attached around the rotary shaft 13. A ring gasket 32 is further disposed between the other bearing 30 and the accommodating tube 221. The presence of the ring gasket 32 enables the bearing to be more firmly accommodated in the positioning space 2211.

In assembly, an insulation material such as plastic or rubber is injected over outer surfaces of the stator core 21, the terminals 27 and the damping member (29)s 29 to form the bobbin 22, with the stator core 21 being received in the receiving groove 227, the inserting plates 272 of the terminals 27 being fixed to the protruding blocks 2233 of the bobbin 22, and the damping member (29)s 29 being received in the mounting holes 2231 and fixed relative to the bobbin 22. The winding block 2251 of each winding bracket 225 is wound with one winding 23, and the windings 23 are connected with corresponding terminals 27. The fasteners 28 extend through the damping member (29)s 29 and are fixed to the external component, so as to connect the bobbin 22 with the external component. The two bearings 30 are respectively accommodated in the positioning spaces 2211, and the ring gasket 32 is disposed between one bearing 30 and the accommodating tube 221. The permanent magnets 12 are installed to the lateral wall 112 of the housing 11, and the stator 20 is accommodated in the accommodating chamber 113. One end of the rotary shaft 13 extends through the through hole 115, the washer 31 and the accommodating tube 221 from an outer side of the end wall 111, with the two bearings 30 disposed around the rotary shaft 13, and the washer 31 abutting against between the end wall 111 and one bearing 30.

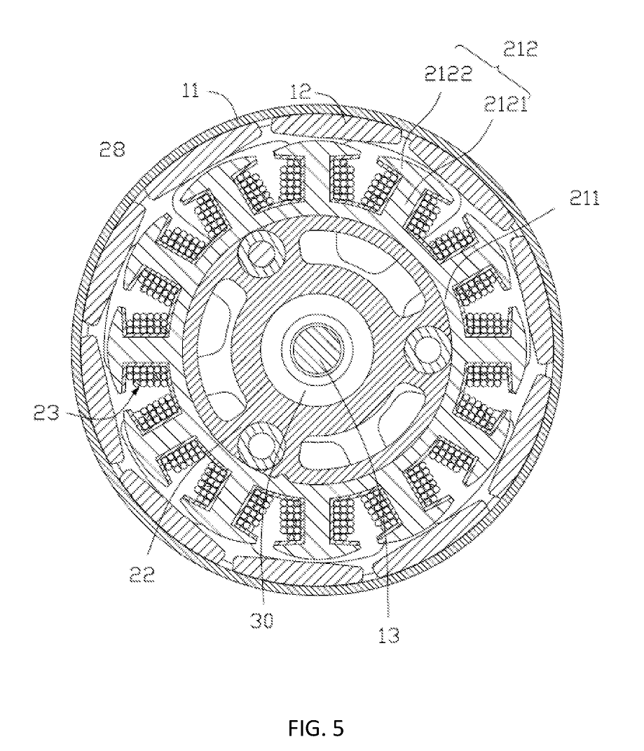

Referring to FIG. 5 again, upon the windings 23 being energized, the permanent magnets 12 rotate around the stator teeth 212. The rotation of the permanent magnets 12 drives the housing 11 and the rotary shaft 13 to rotate, thereby driving one external component (not shown) connected with the rotary shaft 13 to rotate.

Referring also to FIG. 6, FIG. 6 is an enlarged view of a portion of one permanent magnet 12 and one stator tooth 212. A minimum distance between the pole shoe and the corresponding permanent magnet is defined as D. When one of the pole shoes 2122 is completely aligned with one of the permanent magnets 12 as shown is FIG. 6, D is a length of a line segment ab defined between a central point a of the external end surface of the pole shoe 2122 and a central point b of the pole face 120. The line segment ab has a midpoint c. A circular arc line I shown in FIG. 6 is a centerline of the air gap between the permanent magnet 12 and the stator core 21 at this state. The air gap centerline I has a radius equal to a distance from a central point (not shown) of the stator core 21 to the midpoint c. A distance between lateral ends of two adjacent pole shoes 2122, i.e. a slot width of the stator core 21, is defined as C, which is a length of a line segment II in FIG. 6. A distance from a slot center point, i. e. a midpoint d of the line segment II, to the air gap centerline I along a radial direction of the stator core 21 is defined as B, which is a length of a line segment III in FIG. 6. A distance from the air gap centerline I to the permanent magnet 12 along the axial direction of the stator core 21 through the slot center point is defined as A, which is a length of the a line segment VI linearly extending from the line segment III.

The values of A, B, C and D satisfy the following formulas:

A=B; (Formula 1)

A+B=(4˜5)*D; (Formula 2)

C=(0.9˜1.1)*(A+B); (Formula 3)

In the motor 100 according to the embodiment of the present invention, when A, B, C and D, which indicate the distances defined by relationship between the permanent magnet 12 and the pole shoe 2122, satisfy the above formulas, the motor 100 can significantly reduce noise and improve the NVH performance.

The above embodiments are merely to illustrate the technical solutions of the present invention and are not intended to limit the present invention. Although the present invention has been described with reference to the above preferred embodiments, it should be appreciated by those skilled in the art that various modifications and variations may be made without departing from the spirit and scope of the present invention.

1. A motor comprising:
a stator comprising a stator core comprising a magnetic yoke and a plurality of stator teeth, each of the stator teeth comprising a tooth portion and a pole shoe, a slot with a width C defined between neighboring pole shoes; and
a rotor comprising a plurality of permanent magnets, each permanent magnet defines a pole face facing the stator core, an air gap being formed between the permanent magnets and the stator core;
wherein a minimum distance between one of the pole shoes and the corresponding one of the permanent magnets is defined as D, a distance from a slot center point of one of the slot of the stator core to an air gap centreline along a radial direction of the stator core is defined as B, a distance from the air gap centerline to the corresponding one of the permanent magnets along the axial direction of the stator core through the slot center point is defined as A, wherein the values of A, B, C and D satisfy the following formulas:
A=B;
A+B=(4˜5)*D; and
C=(0.9˜1.1)*(A+B).

2. The motor of claim 1, wherein the pole face of each permanent magnet comprises an curved segment at the circumferential center thereof, and two chamfers respectively adjoining opposite sides of the curved segment.

3. The motor of claim 2, wherein a curvature of the curved segment is equal to that of the external end surface of the pole shoe.

4. The motor of claim 3, wherein the value of D is equal to a distance between a central point of an external end surface of one of the pole shoes and a central point of the pole face of one of the permanent magnets in response to the pole shoe being completely aligned with the permanent magnet.

5. The motor of claim 3, wherein the motor is an outer-rotor motor, and the stator teeth are disposed at an outer circumferential surface of the magnetic yoke.

6. The motor of claim 5, wherein the stator further comprises stator windings corresponding to the stator teeth, and each of the stator windings is wound around the tooth portion of one stator tooth.

7. The motor of claim 6, wherein the stator further comprises a bobbin, the bobbin is formed on an outer surface of the stator core by injection molding, the stator core is accommodated in the bobbin, and the stator windings are wound around the bobbin.

8. The motor of claim 7, wherein the bobbin comprises an annular frame and a plurality of winding brackets connected to an outer circumferential surface of the annular frame, each of the winding brackets comprises a winding block and a curved baffle, a receiving groove is defined in each of the winding brackets towards the annular frame, the stator core is received in the receiving groove, an external end surface of the pole shoe is flush with an external end surface of the curved baffle, the tooth portions are received in the winding blocks, the magnetic yoke is received in the annular frame, and the stator windings are respectively wound around the winding blocks.

9. The motor of claim 7, wherein a plurality of mounting holes is defined in the annular frame along an axial direction of the bobbin, and the stator is connected to an external component by a plurality of fasteners passing through the corresponding mounting holes to connect with the external component.

10. The motor of claim 8, wherein a damping member is mounted in each of the mounting holes, and the stator is connected to the external component by the fasteners passing through the corresponding damping members to connect with the external component.

11. The motor of claim 7, wherein the stator further comprises a plurality of terminals, and the terminals are connected to the annular frame.

12. The motor of claim 11, wherein protruding blocks protrude from the annular frame, corresponding to the terminals, a connection groove is defined in a distal end of each of the protruding blocks, and the terminals are inserted into the connection grooves, respectively.

13. The motor of claim 7, wherein the bobbin further comprises an hollow accommodating tube, the annular frame extends from an outer circumferential surface of the accommodating tube along an axial direction, positioning spaces are defined in two ends of the accommodating tube, each of the positioning spaces accommodates a bearing, the rotor further comprises a rotary shaft, and the rotary shaft extends through the accommodating tube, with the bearings disposed around the rotary shaft.

14. The motor of claim 13, wherein a ring gasket is disposed between at least one of the bearings and the accommodating tube.

15. The motor of claim 13, wherein the rotor comprises a housing, the housing comprises an end wall and a lateral wall, the end wall and the lateral wall cooperatively bounding an accommodating chamber, the stator is accommodated in the accommodating chamber, the permanent magnets are installed to the lateral wall, the rotary shaft further extends through the end wall and is fixed relative to the end wall.

16. The motor of claim 15, wherein a washer is attached around the rotary shaft, and the washer is disposed between the end wall and one of the bearings.

17. The motor of claim 15, wherein a protrusion protrudes from one side of the end wall away from the lateral wall, and the rotary shaft extends through the protrusion and is interference-fit with the protrusion.

18. The motor of claim 15, wherein a plurality of heat dissipation holes is defined in the end wall.
